(19) United States
(12) Patent Application Publication
(10) Pub. No.: US 2014/0008373 A1
(43) Pub. Date: Jan. 9, 2014

(54) MULTILAYER LINER FOR A HIGH-PRESSURE GAS CYLINDER

(71) Applicants: Jeffrey Sharp, Cochrane (CA); Joel Runka, Calgary (CA)

(72) Inventors: Jeffrey Sharp, Cochrane (CA); Joel Runka, Calgary (CA)

(73) Assignee: Luxfer Canada Limited, Calgary, AB (CA)

(21) Appl. No.: 14/008,391

(22) PCT Filed: Mar. 29, 2012
(86) PCT No.: PCT/CA12/50202

§ 371 Date: Sep. 27, 2013

Related U.S. Application Data
(60) Provisional application No. 61/470,555, filed on Apr. 1, 2011.

(51) Int. Cl. F17C 1/00

(52) U.S. Cl. CPC F17C 1/00
USPC 220/586

(57) ABSTRACT

A multilayer liner for a high-pressure gas cylinder is provided. The liner has an impact-modified polyamide (PA) layer in contact with the high-pressure gas. The impact-modified PA layer reduces travel of the high-pressure gas from the inside of the liner to the outside of the liner. Use of a gas barrier layer such as an EVOH layer in combination with the impact-modified PA layer results in improved permeation resistance not heretofore demonstrated in a Type 4 cylinder. Combination of the EVOH layer and the impact-modified PA layer results in an interior surface which is compatible with gas environment in the cylinder, ductility at high pressures, a range of temperatures, and can survive cryogenic conditions.

### CROSS REFERENCE TO RELATED APPLICATION

This application is a regular application claiming priority of U.S. Provisional Patent application Ser. No. 61/470,555 filed on Apr. 1, 2011, the entirety of which is incorporated herein by reference.

### FIELD

Embodiments described herein relate to a multilayer liner for a high-pressure gas cylinder. More particularly, the liner comprises at least one inner layer having low gas permeability characteristics in direct contact with a compressed high-pressure gas.

### BACKGROUND

High-pressure gas cylinders are used to store gases such as hydrogen or natural gas. Gas cylinders are often used to store fuel on board vehicles. Typical or standard storage pressures are 350, 450 and 700 bar. Conventional high-pressure cylinders consist of an internal liner or bladder having an outer structure or constraint layer of fiber-reinforced plastic (FRP) to resist the internal gas pressure. The internal liner acts as a gas barrier. In order to maximize the amount of fuel stored within the limited confines of a vehicle, the liner should store the gas at the highest allowable pressure, the liner should be as thin and lightweight as possible, and the liner must also resist the loss of gas through permeation. Liners are conventionally made from aluminum (Type 3 cylinder) or from a thermoplastic (Type 4 cylinder).

Aluminum liners have excellent permeation barrier and heat transfer properties. However, whilst efforts have been made to minimize weight, aluminum liners are still thicker and heavier than desired.

Thermoplastic liners are conventionally made of a single layer of high density polyethylene (HDPE) or a polyamide (PA). Such materials have densities less than half that of aluminum, however they have poor permeation barrier properties. Mono-layer liners made of HDPE theoretically require a thickness of up to about 30 mm to satisfy a permeation limit of 1 Ncc per hour of hydrogen gas per liter of internal volume at a pressure of 700 bar. However, manufacturing a cylinder comprising a HDPE liner of 30 mm thickness is not practical as this would increase the weight and cost of the cylinder. Existing HDPE liners are typically 6 mm thick and do not provide the required permeation resistance to hydrogen gas.

HDPE liners are conventionally used in the automotive industry for storing compressed natural gas (CNG). Natural gas is typically mixed with an odorant such as mercaptan. Mercaptan odorants tend to permeate the HDPE and result in an offensive odor in the vehicle.

Ethylene Vinyl Alcohol (EVOH) is a thermoplastic having low gas permeability characteristics. Multilayer containers comprising layers of various thermoplastics in combination with a layer of EVOH are known for packaging of food. It is also known to manufacture multilayer gasoline tanks incorporating a layer of EVOH between thermoplastic layers. However, Applicant is not aware of such containers or tanks being successfully used to contain gases at high pressures (350 bar and above). It is known that EVOH is brittle and not suitable on its own for forming a structure capable of conventional usage environments. Such low permeability layers also require some form of protective layer.

U.S. Pat. No. 7,549,555 to Suzuki teaches a multilayer liner including EVOH. In one embodiment, the EVOH layer is sandwiched between two or more layers of thermoplastic. The EVOH layer is bonded to the thermoplastic layers by a tie layer. It is Applicant's experience that when such a multilayer liner is used to store high-pressure gas, the gas permeates through the thermoplastic layer in direct contact with the gas and saturates the tie layer. When the liner is depressurized, the gas returns to its gaseous state and comes out of tie layer causing delamination of the multilayer liner.

Another embodiment of Suzuki teaches using EVOH as the innermost layer of the liner in direct contact with the gas. Applicant has discovered that EVOH is subject to cracking when exposed to water at high pressures. As the atmosphere in the Suzuki liner cannot be maintained moisture free, the EVOH layer is at risk. Therefore, EVOH is not viable as the innermost layer of a liner where the atmosphere in the liner cannot be maintained moisture-free.

To date Applicant is not aware of a liner system which is suitable for storing gases at high pressures without cracking, is lightweight, can be adapted for fuel gases, is suitably rugged for industrial handling and use, and yet is highly resistant to permeation of the contained gases.

### SUMMARY

Embodiments described herein relate to a liner for storing compressed high-pressure gases such as natural gas or hydrogen gas. In an aspect, the liner comprises an impact-modified polyamide (PA) layer in direct contact with the high-pressure gas. During operation, the liner reduces permeation of the compressed gas from the inside of the liner to the outside of the liner. Use of a gas barrier layer such as Ethylene Vinyl Alcohol (EVOH) in combination with an impact-modified PA 6 layer increases permeation resistance of the liner especially to low molecular weight gases such as hydrogen. Imapct-modified PA layers tend to exhibit the following characteristics: low gas permeability, ductility at high pressures and a range of temperatures and survival at cryogenic conditions. Impact-modified PA 6 layers also tend to exhibit inherent affinity to EVOH thereby eliminating an adhesive tie layer and resulting delamination.

Accordingly in one broad aspect a light weight storage cylinder for a compressed high-pressure gas is provided. The cylinder has a liner wrapped with a constraint layer. The liner comprises a first, inner layer of impact-modified polyamide (PA) in contact with the gas. The liner also comprises an outer thermoplastic layer in contact with the constraint layer, and an adhesive tie layer between the first, inner impact-modified PA layer and the outer thermoplastic layer.

### BRIEF DESCRIPTION OF THE DRAWINGS

FIG. 1 is a schematic cross-sectional view of one embodiment of a high-pressure gas cylinder showing various layers of a liner;

FIG. 2 is a schematic cross-sectional view of another embodiment of a high-pressure gas cylinder showing various layers of a liner; and

FIG. 3 is a schematic cross-sectional view of another embodiment of a high-pressure gas cylinder showing various layers of a liner.

### DETAILED DESCRIPTION OF THE PREFERRED EMBODIMENTS

Herein, embodiments of the description are directed to a liner for a cylinder storing gas under high pressures. The liner is wrapped with a constraint layer to form the cylinder. The liner comprises at least one impact-modified polyamide (PA) layer for reducing permeation of the gas from the inside of the cylinder to the outside of the cylinder. Embodiments described herein are also directed to a liner comprising a gas barrier layer in combination with an impact-modified PA layer for increasing the permeation resistance of the liner.

Polyamides (PAs) are polymers where the repeating units are held together by amide links. An amide group has the formula CONH₂. Typically, PAs are formed by reacting diamine and diacid monomer units (e.g., nylon 6,6), or by polymerizing an amino carboxylic acid or caprolactam (e.g., nylon 6). Impact modifiers are used to manipulate the properties of PAs such as to impart sufficient tensile elongation at yield and break. An example of an impact modifier includes any rubbery, low-modulus functionalized polyolefin. The impact-modified PA can be any PA with a PA 6 subgroup such as PA 6, PA 6-6,6 or PA 6-12. A discussion of various impact-modified polyamides is set forth in US patent application 2008/0241562 A1 to Bushelman et al.

Impact-modified PA 6 is disclosed in EP Patent No. 0585459 to Matsui which can include a blend of an amorphous polyamide and a crystalline polyamide. Another source of impact-modified PA 6 is Selar® PA T100, a registered trademark of, and manufactured by, Dupont, Del., USA. Details of PA T100 including properties, processing temperatures, drying details and safety hazards are available at http://www.dupont.com. Important properties of PA T100, extracted from the manufacturer's data sheet, are summarized in Table 1.

TABLE 1
Properties (*) of Selar ® PA T100

| | | | Sample |
|---|---|---|---|
| | Units | Test Method | Values |
| PROPERTY | | | |
| Density | g/cc | ASTM D792 | 1.04 |
| MFI (235 C./2.16 kg) | g/10 min | ASTM 1238 | 2.8 |
| Melting Point | ° C. | ASTM D-3418 | 220 |
| Recrystallization Point | ° C. | ASTM D-3418 | 186 |
| MECHANICAL | | | |
| Tensile strength (50 mm/min) | MPa | ASTM D-638 | 40 |
| Elongation at Break (50 mm/min) | % | ASTM D-638 | 190 |
| Flexural Strength | MPa | ASTM D-790 | 56 |
| Flex Modulus | | ASTM-790 | 1400 |
| Izod Impact Strength (notched) | | | |
| 23° C. | J/m | ASTM D-256 | 320 |
| −30° C. | J/m | ASTM D-256 | 415 |
| −40° C. | J/m | ASTM D-256 | 270 |
| OTR @23° C. and 50% RH | Cc 100 | ASTM D-3985 | 20 |
| | μm/ | | |
| | m2 day | | |

(*) Properties measured on an experimental lot.

A cylinder for storing high-pressure gas is formed by wrapping the multilayer liner with a constraint layer. The constraint layer provides the requisite pressure rating or capability. The one or more impact-modified PA layer(s) of the liner improves permeability characteristics of the liner. The storage cylinder can be used for automotive applications, long term storage applications such as backup power supply, gas transport, aerospace and space applications. The impact-modified PA layer reduces travel or permeation of the gas from the inside of the cylinder to the outside compared to a HDPE layer. The impact-modified PA layer is compatible with the pressurized gas environment within the cylinder. The liner also comprises at least one thermoplastic layer which forms a protective layer, protects the liner against impact and acts as an outside-to-inside moisture barrier. The impact-modified PA layer and the thermoplastic layer are generally bonded by a tie layer. In order to further increase the permeation resistance of the liner, especially when low molecular weight gas such as hydrogen is stored therein, the liner may also comprise a gas barrier layer in combination with the impact-modified PA layer. The impact-modified layer protects the gas barrier layer from the gas environment inside the liner and the gas barrier layer reduces permeation of the hydrogen gas from the inside of the liner to the outside.

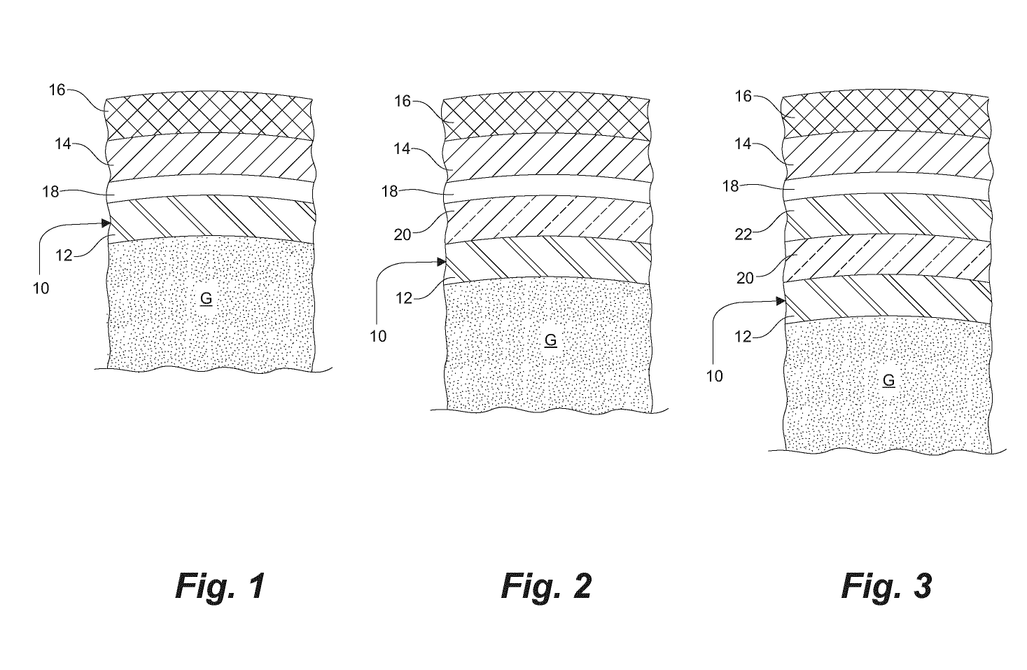

In one embodiment as shown in FIG. 1 (thickness of layers are not to scale), the liner 10 comprises the following layers from the inside, the gas side to outside, the environment: a first, inner layer of impact-modified polyamide (PA) 12 in contact with the high-pressure gas G, an outer thermoplastic layer 14 in contact with a constraint layer 16; and having an adhesive tie layer 18 between the first, inner impact-modified PA layer and 12 the outer thermoplastic layer 14.

In another embodiment as shown in FIG. 2, the liner 10 comprises the following layers from the inside, the gas side to outside, the environment: a first, inner layer of impact-modified polyamide (PA) 12 in contact with the high-pressure gas G, a gas barrier layer 20 between the first, inner impact-modified PA layer and an adhesive tie layer 18, and an outer thermoplastic layer 14 between the adhesive tie layer 18 and a constraint layer 16.

In yet another embodiment, the liner 10 comprises the following layers from the inside, the gas side to outside, the environment: a first, inner layer of impact-modified polyamide (PA) 12 in contact with the high-pressure gas G, a gas barrier layer 20 between the first, inner impact-modified layer 12 and a second, inner impact-modified PA layer 22; an outer thermoplastic layer 14 in contact with a constraint layer 16; and having an adhesive tie layer 18 between the second, inner impact-modified PA layer 22 and the outer thermoplastic layer 14.

In one embodiment, the impact-modified PA layer can have a chemical structure, which is illustrative of PA 6

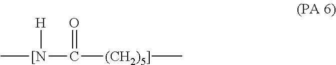

In another embodiment, the impact-modified PA layer can have a chemical structure, which is illustrative of PA 6-6,6

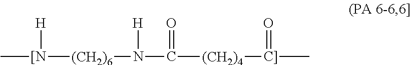

In another embodiment, the impact-modified PA layer can have a chemical structure, which is illustrative of PA 6-12

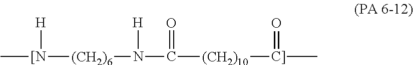

In yet another embodiment, the chemical structure of the first and second impact-modified PA layers can be a combination of

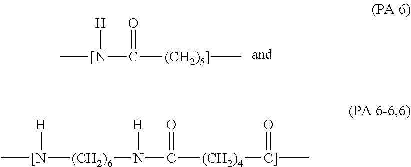

In one embodiment, each of the first and second impact-modified PA layers can have an elongation at break in the range of about 150% to about 200%.

In one embodiment, each of the first and second impact-modified PA layers can have a thickness in the range of about 0.05 mm to about 0.3 mm.

In one embodiment, the gas barrier layer can be an ethylene vinyl alcohol (EVOH) layer.

In one embodiment, the gas barrier layer can have a thickness in the range of about 0.05 up to about 0.3 mm.

In one embodiment, the outer thermoplastic layer can be a high density polyethylene (HDPE) layer having a thickness in the range of about 1 mm to about 1.2 mm.

In another embodiment, the outer thermoplastic layer can be a thermoplastic that can co-extrude with the gas barrier layer and the impact-modified PA layer.

In one embodiment, the adhesive tie layer can be an anhydride modified polyolefin tie layer.

In another embodiment, the adhesive tie layer can be a maleic anhydride modified HDPE tie layer.

In one embodiment, thickness of the adhesive tie layer can be in the range of about 0.5 mm to about 0.2 mm.

In one embodiment, the storage cylinder can store natural gas at pressures of about 250 bar. Typically, during storage, natural gas is mixed with an odorant such as mercaptan. The impact-modified PA layer is resistant to permeation of the odorant and substantially reduces permeation of odour from the gas to the outside of the cylinder thereby reducing one problem frequently encountered in conventional Type 4 storage cylinders for natural gas.

In another embodiment, the storage cylinder can store hydrogen gas at pressures of about 700 bar. Hydrogen gas has a low molecular weight and is especially vulnerable to permeation through barriers. For storage of hydrogen gas, the liner typically comprises a gas barrier layer such as EVOH in combination with the impact-modified PA layer. The EVOH layer in combination with the impact-modified layer increases the permeation resistance of the liner. Also, as the impact-modified layer, which is in direct contact with the hydrogen gas, is compatible with the environment inside the liner, the impact-modified PA layer protects the brittle EVOH layer from the environment inside the liner.

During use or operation of the cylinder, the one or more impact-modified PA layer(s) of the liner, having low gas permeability characteristics, reduces permeation of compressed gas from the inside of the cylinder to intermediate layers or the outside of the cylinder including low molecular weight gases. In use, as the cylinder is decompressed, cryogenic conditions can result. As the impact-modified PA layer remains ductile at high pressures and a range of temperatures, the cylinder can survive such cryogenic conditions without cracking. In one embodiment, the liner comprises an EVOH layer sandwiched between two, impact-modified PA 6 layers. It is known that PA 6 has an inherent affinity to EVOH and during manufacture, the outer and inner impact-modified PA 6 layers bond naturally to EVOH making it an inseparable or integrated structure. The phrase “bond naturally” means that the PA6 and EVOH bond or adhere to each other without an intervening tie layer. The PA 6 layer in direct contact with the gas protects the relatively brittle EVOH layer from the gas environment inside the liner. Also, as the EVOH bonds naturally to the PA 6 layer, no interface exists between the EVOH and the PA 6 layers. As no adhesive tie layer is required, problems associated with the Suzuki patent such as eventual saturation of a tie layer and subsequent delamination on decompression is eliminated. The impact-modified PA 6 layer in contact with the gas is resistant to moisture and acts as a sufficient barrier to protect the EVOH. The impact-modified PA layer does not crack when exposed to water at high pressures and creates an internal surface compatible with the cylinder's internal environment. Therefore, the second problem encountered in Suzuki is also eliminated by the liner disclosed herein.

Liners manufactured according to embodiments disclosed herein are light weight. For an internal volume of 40 liters, a liner described herein would weigh approximately 2 kg, whereas a prior art aluminum liner would weigh approximately 8 kg.

In one embodiment, the liner can be formed by coextrusion blow molding. This method of manufacture results in a thin-walled and accurate construction of the liner with high throughput. Blow molding is known such as that disclosed in U.S. Pat. No. 6,033,749 to Hata.

In one embodiment, the multilayer liner can be circular in cross section and is closed at both ends with a dome. At least one opening is available in one of the domes along the axis of the liner to allow for filling and emptying.

### Example 1

In an example, a multilayer liner manufactured according to embodiments described herein comprises the following layers from the inside (gas side) to outside (environment):
Impact-modified PA 6 layer Selar® PA T100 having a thickness of about 0.2 mm
EVOH (EVAL™, a registered trademark of, and manufactured by, Kuraray F101B 32 mol % EVOH copolymer) having thickness of about 0.2 mm
Impact-modified PA 6 layer Selar® PA T100 having a thickness of about 0.2 mm
HDPE tie (DuPont™ Bynel® 40E529, a registered trademark of, and manufactured by, DuPont) having thickness of about 0.2 mm
HDPE (Basell Lupolen 4261 AG) having thickness of about 1.2 mm

### Example 2

In an example, a multilayer liner manufactured according to embodiments described herein comprises the following layers from the inside (gas side) to outside (environment):
Impact-modified PA 6 layer Selar® PA T100 having a thickness of about 0.2 mm
EVOH (EVAL™, a registered trademark of, and manufactured by, Kuraray F101B 32 mol % EVOH copolymer) having thickness of about 0.2 mm
HDPE tie (DuPont™ Bynel® 40E529, a registered trademark of, and manufactured by, DuPont) having thickness of about 0.2 mm
HDPE (Basell Lupolen 4261 AG) having thickness of about 1.2 mm

The liner of examples 1 and 2 can store hydrogen gas at 700 bar and demonstrates an overall permeation rate as low as 0.03 Ncc/hr/litre of H₂ over a 500 hour test interval. Further, the liner did not evidence line collapse, cracking, delamination or degradation from repeated pressurization/depressurization cycles over a 2000 hour test interval, and throughout an operating temperature range of −40° C. through +85° C.

### Example 3

In an example such as that for natural gas, a multilayer liner manufactured according to embodiments described herein comprises the following layers from the inside (gas side) to outside (environment):
Impact-modified PA 6 layer Selar® PA T100 having a thickness of about 0.2 mm
HDPE tie (DuPont™ Bynel® 40E529, a registered trademark of, and manufactured by, DuPont) having thickness of about 0.2 mm
HDPE (Basell Lupolen 4261 AG) having thickness of about 1.2 mm

1. A light weight storage cylinder for a compressed high-pressure gas, the cylinder having a liner wrapped with a constraint layer, the liner comprising:
a first, inner layer of impact-modified polyamide (PA) in contact with the gas,
an outer thermoplastic layer in contact with the constraint layer; and
an adhesive tie layer between the first, inner impact-modified PA layer and the outer thermoplastic layer.

2. The storage cylinder of claim 1 wherein the first impact-modified PA layer has an elongation at break in the range of about 150% to about 200%.

3. The storage cylinder of claim 1 wherein the first impact-modified PA layer has a thickness in the range of about 0.05 mm to about 0.3 mm.

4. The storage cylinder of claim 1 further comprising a gas barrier layer between the first impact-modified layer and the adhesive tie layer.

5. The storage cylinder of claim 4 wherein the gas barrier layer is an ethylene vinyl alcohol (EVOH) layer.

6. The storage cylinder of claim 5 further comprising a second, inner impact-modified PA layer, wherein
the adhesive tie layer is sandwiched between the second, inner impact-modified PA layer and the outer thermoplastic layer; and
the EVOH layer is sandwiched between the first, inner impact-modified PA layer and the second, inner impact-modified PA layer.

7. The storage cylinder of claim 5 wherein the chemical structure of the impact-modified PA is

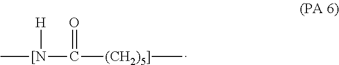

8. The storage cylinder of claim 5 wherein the chemical structure of the impact-modified PA is

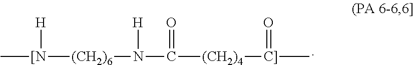

9. The storage cylinder of claim 5 wherein the chemical structure of the impact-modified PA layer is a combination of

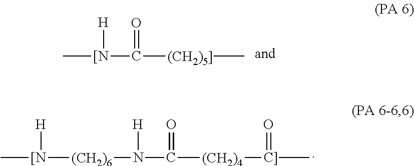

10. The storage cylinder of claim 5 wherein the chemical structure of the impact-modified PA is

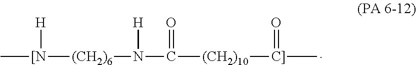

11. The storage cylinder of claim 5 wherein the chemical structure of the impact-modified PA comprises a crystalline polyamide and an amorphous polyamide.

12. The storage cylinder of claim 6 wherein the gas barrier layer has a thickness in the range of about 0.05 up to about 0.3 mm.

13. The storage cylinder of claim 1 wherein the outer thermoplastic layer is a high density polyethylene (HDPE) layer and thickness of the HDPE layer is in the range of about 1 mm to about 1.2 mm.

14. The storage cylinder of claim 1 wherein the liner is formed by coextrusion blow molding and the outer thermoplastic layer is a high density polyethylene (HDPE) layer that will co-extrude with the gas barrier layer and the first and second impact-modified PA layers.

15. The storage cylinder of claim 1 wherein thickness of the adhesive tie layer is in the range of about 0.05 mm to about 0.2 mm.

16. The storage cylinder of claim 15 wherein the adhesive tie layer is an anhydride modified polyolefin tie layer.

17. The storage cylinder of claim 15 wherein the adhesive tie layer is a maleic anhydride modified HDPE tie layer.

18. A storage cylinder comprising the liner of claim 6 for storing compressed high-pressure hydrogen gas wherein combination of the first and second impact modified PA layers and the EVOH layer reduces permeation of the hydrogen gas from the inside of the cylinder to the outside of the cylinder.

19. A storage cylinder comprising the liner of claim 1 for storing compressed high-pressure natural gas wherein the first, inner impact-modified PA layer reduces permeation of the natural gas from the inside of the cylinder to the outside of the cylinder.

20. A storage cylinder comprising the liner of claim 1 for storing compressed high-pressure gas containing moisture.

21. The storage cylinder of claim 1 wherein the gas stored in the cylinder is natural gas mixed with an odorant.

22. The storage cylinder of 21 wherein the odorant is mercaptan.
